(19) United States
(12) Patent Application Publication
(10) Pub. No.: US 2020/0391161 A1
(43) Pub. Date: Dec. 17, 2020

(54) FLUID SEPARATION MEMBRANE

(71) Applicant: TORAY INDUSTRIES, INC., Tokyo (JP)

(72) Inventors: Kentaro TANAKA, Otsu-shi (JP); Yuki YAMASHITA, Otsu-shi (JP); Dai KONDO, Otsu-shi (JP); Kosaku TAKEUCHI, Otsu-shi (JP); Takaaki MIHARA, Otsu-shi (JP); Tomoyuki HORIGUCHI, Otsu-shi (JP)

(73) Assignee: TORAY INDUSTRIES, INC., Tokyo (JP)

(21) Appl. No.: 16/966,606

(22) PCT Filed: Feb. 19, 2019
(86) PCT No.: PCT/JP2019/006148

§ 371 Date: Jul. 31, 2020

(30) Foreign Application Priority Data
Mar. 15, 2018 (JP) 2018-047502

(51) Int. Cl. B01D 69/02; B01D 69/10; B01D 69/14; B01D 71/02

(52) U.S. Cl. CPC B01D 69/02; B01D 69/10; B01D 69/147; B01D 71/021; B01D 2325/023; B01D 53/228; B01D 2325/28; B01D 2325/30; B01D 2257/504; B01D 2256/245; B01D 2325/12

(57) ABSTRACT

The present invention provides a fluid separation membrane that can maintain separation performance for a long period of time. The present invention provides a fluid separation membrane including a separation layer including a dense layer, wherein 2 to 10,000 ppm of a total of a monocyclic or bicyclic aromatic compound being liquid or solid at 16° C. under atmospheric pressure and 10 to 250,000 ppm of water are adsorbed.

### TECHNICAL FIELD

The present invention relates to a fluid separation membrane.

### BACKGROUND ART

Membrane separation is used as a technique for selectively separating a specific component from various mixed gases and mixed liquids for purification. A membrane separation method is attracting attention because the method is energy-saving as compared with other fluid separation methods such as distillation.

For example, in a natural gas refining plant, it is necessary to separate and remove carbon dioxide as an impurity contained in a methane gas as a main component. When applied to such a case, the membrane separation is required to keep high separation performance for a long period of time in an environment exposed to a high gas ejection pressure of several MPa or more.

In the chemical industry, the membrane separation method has begun to be used in the step of separating water as an impurity contained in an alcohol or acetic acid. In also such an application, a fluid separation membrane having high separation performance and long-term stability is required from the viewpoints of the productivity and the quality stability.

For the purpose of the above-described applications, a fluid separation membrane including carbon (for example, described in Patent Document 1), a fluid separation membrane including a polymer (for example, described in Patent Document 2), and the like have been studied.

### PRIOR ART DOCUMENTS

### Patent Documents

Patent Document 1: Japanese Patent Laid-open Publication No. 2007-63081

Patent Document 2: Japanese Patent Laid-open Publication No. 2012-210608

### SUMMARY OF THE INVENTION

### Problems to be Solved by the Invention

With the fluid separation membrane as described in Patent Document 1 or 2, there have been problems that the industrially required separation performance cannot be realized, and the separation performance is deteriorated in long-term use although high separation performance is exhibited in the initial stage of the operation.

The present invention has been made in view of the conventional circumstances described above, and an object of the present invention is to provide a fluid separation membrane that can maintain high separation performance for a long period of time.

### Solutions to the Problems

The present invention for solving the above-described problems is a fluid separation membrane including a separation layer including a dense layer, wherein 2 to 10,000 ppm of a monocyclic or bicyclic aromatic compound being liquid or solid at 16° C. under atmospheric pressure and 10 to 250,000 ppm of water are adsorbed.

### Effects of the Invention

According to the present invention, it is possible to provide a fluid separation membrane that can maintain the separation performance for a long period of time.

### EMBODIMENTS OF THE INVENTION

<Fluid Separation Membrane>

The fluid separation membrane in the present invention (hereinafter sometimes simply referred to as “separation membrane”) is a separation membrane having a dense layer that functions as a substantial fluid separation layer.

The material of the dense layer is not particularly limited, and general inorganic materials and polymer materials can be applied. Inorganic materials are preferable from the viewpoint of suppressing the plasticization, the swelling, and the dimensional change with respect to the aromatic compound that is an adsorbed component in the fluid separation membrane according to the present invention. The inorganic material is not particularly limited, and ceramics such as silica and zeolites, and carbon are preferably used. Among the inorganic materials, carbon is preferably used because carbon has high resistance to water that is an adsorbed component in the fluid separation membrane according to the present invention.

In the case that the material of the dense layer is carbon, the rate of the carbon component is preferably 60 to 95% by weight. In the case that the rate is 60% by weight or more, the heat resistance and the chemical resistance of the fluid separation membrane tend to be improved. The rate of the carbon component in the dense layer is more preferably 65% by weight or more. In the case that the rate of the carbon component in the dense layer is 95% by weight or less, flexibility is generated, the bend radius is reduced, and the handleability is improved. The rate of the carbon component in the dense layer is more preferably 85% by weight or less.

Here, the rate of the carbon component is a weight fraction of the carbon component when the total of the carbon, hydrogen, and nitrogen components measured by an organic element analysis method is regarded as 100%. In the case that the dense layer, another support described below, and the like in the separation membrane all include carbon, do not have clear boundary between them, and are considered to include a uniform carbon material, the rate may be a value quantified with respect to the whole separation membrane.

The portion other than the dense layer in the fluid separation membrane may include the same material as the dense layer or may include a different material, and preferably includes the same material from the viewpoint of suppressing peeling and a crack to improve the quality stability.

From the viewpoints of pressure resistance and strength, examples of the preferred form of the fluid separation membrane according to the present invention include forms in which the dense layer is formed on the surface of a support having a porous structure. The material of the support is not particularly limited, and inorganic materials, polymer materials, and the like can be applied. Carbon is preferably used from the viewpoint of suppressing the structural change and the dimensional change with respect to the aromatic compound and water that are adsorbed components in the fluid separation membrane according to the present invention.

From the viewpoint of fluid permeability, the porous structure of the support is preferably a three-dimensional network structure. The three-dimensional network structure is a structure including branches and pores (voids) that are three-dimensionally continuous separately, and can be confirmed with the branches and the voids separately continuous that are observed by cutting a specimen that has been sufficiently cooled in liquid nitrogen with tweezers or the like to produce a cross section, and viewing the cross-sectional surface with a scanning electron microscope. The three-dimensional network structure produces an effect that the branches support one another to maintain the entire structure, and the stress is distributed throughout the structure. Therefore, the support has great resistance to external forces such as compression and bending, and the compressive strength and the compressive specific strength can be improved. Furthermore, because three-dimensionally linked with one another, the voids serve as a flow path for supplying or discharging a fluid such as a gas or a liquid.

Among the three-dimensional network structures, a co-continuous porous structure is particularly preferable in which branches and pores (voids) of the framework are separately regularly intertwined three dimensionally while being continuous. The presence of the co-continuous porous structure can be confirmed with the branches and the voids of the framework separately intertwined while being continuous that are observed by cutting a specimen to produce a cross section and viewing the cross-sectional surface with a scanning electron microscope in the same manner as described above. For example, a structure in which a straight tube (cylindrical) hole is formed from the front side to the back side of the membrane is a three-dimensional network structure, but is not included in examples of the co-continuous porous structure because the branches and the voids are not intertwined.

The average diameter of the pores in the porous structure of the support is preferably 30 nm or more because the pressure loss is reduced and the fluid permeability is enhanced owing to such an average diameter, and the average diameter is more preferably 100 nm or more. The average diameter is preferably 5,000 nm or less because, owing to such an average diameter, the effect that the portions other than the pore support one another to maintain the entire porous structure is enhanced to increase the compressive strength, and the average diameter is more preferably 2,500 nm or less. Here, the average diameter of the porous structure is a value determined by measuring the pore diameter distribution of the fluid separation membrane by the mercury intrusion method. In the mercury intrusion method, a pressure is applied to the pores in the porous structure so that mercury is infiltrated into the pores, and the pore volume and the specific surface area of the pores are determined from the pressure and the amount of the mercury intruded in the pores. Then, the pore diameter is calculated from the relationship between the pore volume and the specific surface area when the pores are assumed to be cylindrical, and a pore diameter distribution curve of 5 nm to 500 μm can be obtained by the mercury intrusion method. Because the dense layer has substantially no pores, the average diameter of the pores measured using the entire separation membrane as a sample can be regarded as substantially the same as the average diameter of the pores in the porous structure.

The porous structure of the support preferably has a structural period, and the structural period is preferably 10 to 10,000 nm. The fact that the porous structure has a structural period means that the uniformity of the porous structure is high, the thickness and the pore size of the framework are uniform, and high compressive strength is easily obtained. In the case that the structural period is 10,000 nm or less, the framework and the pores have a fine structure, and the compressive strength is improved. The structural period of the porous structure is more preferably 5,000 nm or less, and still more preferably 3,000 nm or less. In the case that the structural period is 10 nm or more, the pressure loss during flowing a fluid through the pores is reduced, the permeation rate of a fluid is improved, and the fluid can be separated with more energy saving. The structural period of the porous structure is more preferably 100 nm or more, and still more preferably 300 nm or more.

The structural period of the porous structure is calculated from the scattering angle 20 in accordance with a formula shown below. The scattering angle 20 corresponds to the position of a peak top of scattered-light intensity that is obtained by irradiating the porous structure with X-rays, and performing small-angle scattering.

$$L = \frac{λ}{2 sin θ} \qquad [ Mathematical 1 ]$$

L: structural period, X: wavelength of incident X-rays

However, the small-angle scattering sometimes cannot be observed because of the large structural period. In such a case, the structural period is obtained by X-ray computed tomography (X-ray CT). Specifically, a three-dimensional image captured by X-ray CT is subjected to Fourier transform to produce a two-dimensional spectrum, and the two-dimensional spectrum is processed by circular averaging to produce a one-dimensional spectrum. The characteristic wavelength corresponding to the position of a peak top in the one-dimensional spectrum is determined, and the structural period is calculated as the inverse of the wavelength.

Furthermore, the more uniform the porous structure is, the more effectively the stress is distributed throughout the structure, and the higher the compressive strength is. The uniformity of the porous structure can be determined with the half-value width of a peak of scattered-light intensity of X-rays. Specifically, the porous structure of the support is irradiated with X-rays, and the smaller the half-value width of the obtained peak of scattered-light intensity is, the higher the uniformity is determined to be. The half-value width of the peak is preferably 5° or less, more preferably 1° or less, and still more preferably 0.1° or less. The term “half-value width of a peak” in the present invention means the width determined in the following manner. Specifically, the vertex of the peak is named point A, and a straight line parallel to the ordinate of the graph is drawn from point A. The intersection of the straight line and the baseline of the spectrum is named point B, and the width of the peak as measured at the center C of the segment that connects point A and point B is defined as the half-value width. The term “width of the peak” herein means the length between the intersections of the scattering curve and the straight line that is parallel to the baseline and passes through point C.

The specific surface area of the separation membrane is preferably 10 to 1,500 m²/g or more. Because a specific surface area of 10 m²/g or more increases the area that can act on the adsorption of an aromatic compound and water, and because the specific surface area enhances the durability, the specific surface is preferably 10 m²/g or more, more preferably 20 m²/g or more, and still more preferably 50 m²/g or more. Because a specific surface area of 1,500 m²/g or less increases the membrane strength, and because the specific surface area enhances the handleability, the specific surface area is preferably 1,500 m²/g or less, more preferably 1,000 m²/g or less, and still more preferably 500 m²/g or less. The specific surface area in the present invention can be calculated based on the BET formula from the data of an adsorption isotherm measured by adsorbing and desorbing nitrogen on the fluid separation membrane in accordance with JIS R 1626 (1996).

The shape of the fluid separation membrane according to the present invention is not particularly limited, and examples of the shape include a fiber shape and a film shape. From the viewpoints of high filling efficiency, high separation efficiency per volume, and excellent handleability, a fiber shape is more preferable. Here, an object having a “fiber shape” refers to an object having a ratio of the length L to the diameter D (aspect ratio L/D) of 100 or more. The separation membrane having a fiber shape will be described below.

The shape of the fiber cross section is not limited, and the fiber cross section can have any shape and can be a hollow cross section, a round cross section, a polygonal cross section, a multi-lobe cross section, a flat cross section, or the like. The fiber cross section is preferably a hollow cross section, that is, a cross section having a hollow fiber shape because such a cross section reduces the pressure loss in the membrane to obtain high fluid permeability as a fluid separation membrane. The hollow portion in a hollow fiber serves as a fluid flow path. The hollow fiber having a hollow portion produces an effect of significantly reducing the pressure loss particularly when a fluid flows in the fiber axis direction in both cases of an external pressure system and an internal pressure system for the fluid permeation, and the fluid permeability is improved. In the case of an internal pressure system, the pressure loss is particularly reduced, so that the permeation rate of a fluid is further improved.

In the case of the fiber shape, the separation membrane preferably has a form in which the dense layer is formed on the surface of the fiber, and the portion other than the dense layer in the fiber is a support having the above-described porous structure. In the case of the hollow fiber shape, the dense layer can be formed on one or both of the inner surface and the outer surface.

Furthermore, in the case that the fluid separation membrane has a small average diameter, the bendability and the compressive strength are improved, therefore the average diameter is preferably 500 μm or less, more preferably 400 μm or less, and still more preferably 300 μm or less. The smaller the average diameter of the fluid separation membrane is, the larger the number of the fibers that can be filled per unit volume is, so that the membrane area per unit volume can be increased, and the permeation flow rate per unit volume can be increased. The lower limit of the average diameter of the fluid separation membrane is not particularly limited and can be arbitrarily determined. From the viewpoint of improving the handleability for manufacturing the fluid separation membrane module, the average diameter is preferably 10 μm or more.

The average length of the fibers can be arbitrarily determined, and is preferably 10 mm or more from the viewpoint of improving the handleability for forming a module and viewpoint of improving the fluid permeation performance.

[Adsorbed Component]

In the fluid separation membrane according to the present invention, 2 to 10,000 ppm of the total of a monocyclic or bicyclic aromatic compound being liquid or solid at 16° C. under atmospheric pressure (hereinafter sometimes referred to simply as “aromatic compound”) and 10 to 250,000 ppm of water are adsorbed.

As a result of the study by the present inventor, the present inventor has found that the separation performance can be maintained for a long period of time because the fluid separation membrane has the above-described adsorbed component although the reason is not clear. In the case that a plurality of aromatic compounds are adsorbed, the above-described aromatic compound adsorption amount is the total of the adsorption amounts of the plurality of aromatic compounds. Note that each aromatic compound having an adsorption amount of 1 ppm or less is treated as not being adsorbed.

The aromatic compound adsorption amount is required to be 2 ppm or more, and is more preferably 10 ppm or more, and still more preferably 100 ppm or more so that the above-described effect is exhibited. From the viewpoint of ensuring sufficient fluid permeability, the aromatic compound adsorption amount is required to be 10,000 ppm or less, and is more preferably 5,000 ppm or less, and still more preferably 1,000 ppm or less.

Specific examples of the monocyclic or bicyclic aromatic compound being liquid or solid at 16° C. under atmospheric pressure include toluene, benzene, ethylbenzene, cumene, phenol, benzyl alcohol, anisole, benzaldehyde, benzoic acid, acetophenone, benzenesulfonic acid, nitrobenzene, aniline, thiophenol, benzonitrile, styrene, xylene, cresol, catechol, resorcinol, hydroquinone, phthalic acid, isophthalic acid, terephthalic acid, salicylic acid, and toluidine. The fluid separation membrane more preferably includes at least one selected from the group consisting of toluene, benzene, and xylene among the above-described compounds because such a fluid separation membrane produces an increased effect of maintaining the separation performance, and the fluid separation membrane still more preferably includes at least one of toluene or benzene, and most preferably includes toluene.

It is preferable that 2 ppm or more of toluene be singly adsorbed because the effect of maintaining the separation performance is particularly increased. It is more preferable that 50 ppm or more of toluene be adsorbed. The toluene adsorption amount is preferably 2,000 ppm or less because, owing to such an adsorption amount, the plasticization of the fluid separation membrane is suppressed to obtain high strength, and the toluene adsorption amount is more preferably 800 ppm or less.

Furthermore, an aspect in which both toluene and benzene are adsorbed is also particularly preferable. In an aspect in which both toluene and benzene are adsorbed, it is preferable that the ratio of the toluene adsorption amount (ppm) to the benzene adsorption amount (ppm) be 2 or more because the effect of maintaining the separation performance is increased owing to such a ratio, and it is particularly preferable that the ratio be 10 or more. The upper limit of the ratio of the toluene adsorption amount (ppm) to the benzene adsorption amount (ppm) is not particularly limited, and the ratio is preferably 200 or less, and more preferably 100 or less so that the effect of the coexistence of toluene and benzene is exhibited.

The water adsorption amount is required to be 10 ppm or more, and is preferably 100 ppm or more because the effect of maintaining the separation performance is increased owing to such an adsorption amount, and the water adsorption amount is more preferably 1,000 ppm or more. Furthermore, the water adsorption amount is required to be 250,000 ppm or less, and is preferably 150,000 ppm or less because the strength of the fluid separation membrane is increased owing to such an adsorption amount, and the water adsorption amount is more preferably 50,000 ppm or less.

The ratio of the water adsorption amount (ppm) to the aromatic compound adsorption amount (ppm) is preferably 0.5 or more because the effect of maintaining the separation performance is increased owing to such a ratio, and the ratio is particularly preferably 3 or more.

The aromatic compound adsorption amount and the water adsorption amount can be quantified by temperature programmed desorption-mass spectrometry (TPD-MS) as follows. First, a heating device equipped with a temperature controller is directly connected to a mass spectrometer to heat the fluid separation membrane in a helium atmosphere. In the temperature program, the temperature is first raised from room temperature to 80° C. at 10° C./min (step 1), held at 80° C. for 30 minutes (step 2), further raised to 180° C. at 10° C./min (step 3), and held at 180° C. for 30 minutes (step 4). Then, the amounts of the aromatic compound and the water vapor in the gas in steps 1 to 4 are measured. In order to exclude the influence of the liquid film and the liquid droplet on the surface of the fluid separation membrane, when the fluid separation membrane is visually wet, the surface of the fluid separation membrane is wiped with a rag or the like before the measurement is performed.

When the aromatic compound adsorption amount obtained only from the aromatic compound gas generated in steps 1 and 2 is Aa (ppm), and the aromatic compound adsorption amount obtained only from the amount of the aromatic compound gas generated in steps 3 and 4 is Ba (ppm), it is preferable that Ba/Aa be 0.1 or more because the separation performance can be maintained for a long period of time in such a case, and Ba/Aa is more preferably 0.2 or more, and still more preferably 0.3 or more.

When the water adsorption amount obtained only from the water vapor generated in steps 1 and 2 is Aw (ppm), and the water adsorption amount obtained only from the amount of the water vapor generated in steps 3 and 4 is Bw (ppm), it is similarly preferable that Bw/Aw be 0.1 or more because the separation performance can be maintained for a long period of time in such a case, and Bw/Aw is more preferably 0.2 or more, and still more preferably 0.3 or more.

When the amount of the aromatic compound (toluene in a particularly preferable aspect) generated in temperature programmed desorption-mass spectrometry (TPD-MS) is online measured while the fluid separation membrane according to the present invention is heated from room temperature to 300° C. at 10° C./min, a curve produced by plotting the amount of the aromatic compound of one kind with respect to the temperature change preferably has two or more peaks. The fact that the curve has two or more peaks means that the aromatic compound is adsorbed not only on the surface of the fluid separation membrane but also inside the fluid separation membrane, and the effect of maintaining the separation performance is increased. When the amount of water generated under the same conditions is online measured, it is preferable that a curve produced by plotting the amount of water with respect to the temperature change have two or more peaks because such a fact means that the water is adsorbed not only on the surface of the fluid separation membrane but also inside the fluid separation membrane, and the effect of maintaining the separation performance is increased. Furthermore, an aspect in which both the curves plotting the amounts of the aromatic compound and water have two or more peaks is particularly preferable.

In order to exclude the influence of the liquid film and the liquid droplet on the surface of the fluid separation membrane, when the fluid separation membrane is visually wet, the surface of the fluid separation membrane is wiped with a rag or the like before the measurement is performed.

The fluid separation membrane according to the present invention is preferably a membrane used for gas separation, that is, a gas separation membrane. The gas separation membrane is particularly preferably used for separation in which an acidic gas is extracted with high concentration from the mixed gas containing the acidic gas. Examples of the acidic gas include carbon dioxide and hydrogen sulfide. From the viewpoint of affinity with water contained in the fluid separation membrane according to the present invention, the fluid separation membrane according to the present invention is preferably used for separation of a mixed gas containing carbon dioxide, particularly preferably separation of a natural gas.

<Method for Manufacturing Fluid Separation Membrane>

The fluid separation membrane according to the present invention can be manufactured by, for example, a manufacturing method including a step of preparing a fluid separation membrane including a separation layer including a dense layer, and a step of adsorbing an aromatic compound and water on the fluid separation membrane.

1. Step of Preparing Fluid Separation Membrane Including Separation Layer Including Dense Layer

A fluid separation membrane before adsorbing an aromatic compound and water may be a commercially available one, or can be produced by, for example, steps 1 to 3 described below. This is an example of a fluid separation membrane in which the dense layer and the support include carbon. Hereinafter, a dense layer including carbon will be referred to as a “dense carbon layer”, and a support including carbon will be referred to as a “porous carbon support”. However, a method for manufacturing a fluid separation membrane in the present invention is not limited to the method described below.

[Step 1: Step of Obtaining Porous Carbon Support]

Step 1 is a step of carbonizing a molded body containing a resin serving as a precursor of a porous carbon support (hereinafter, the resin is sometimes referred to as a “support precursor resin”) at 500° C. or more and 2,400° C. or less to produce a porous carbon support.

The support precursor resin used can be a thermoplastic resin or a thermosetting resin. Examples of the thermoplastic resin include polyphenylene ether, polyvinyl alcohol, polyacrylonitrile, phenol resins, aromatic polyesters, polyamic acids, aromatic polyimides, aromatic polyamides, polyvinylidene fluoride, cellulose acetate, polyetherimide, and copolymers of these resins. Examples of the thermosetting resin include unsaturated polyester resins, alkyd resins, melamine resins, urea resins, polyimide resins, diallyl phthalate resins, lignin resins, urethane resins, phenol resins, polyfurfuryl alcohol resins, and copolymers of these resins. These resins may be used alone, or a plurality of the resins may be used.

The support precursor resin used is preferably a thermoplastic resin capable of solution spinning. From the viewpoints of cost and productivity, polyacrylonitrile or aromatic polyimide is particularly preferably used.

It is preferable to add, to the molded body containing the support precursor resin, a disappearing component that can disappear after molding in addition to the support precursor resin. For example, it is possible to form a porous structure as well as control the average diameter of the pores included in the porous structure by forming a resin mixture with a resin that disappears by post heating during carbonization or the like, or by dispersing particles that disappear by post heating during carbonization or the like or by washing after carbonization or the like.

As an example of a means for finally obtaining the porous structure, an example in which a resin that disappears after carbonization (disappearing resin) is added will be described first. First, the support precursor resin is mixed with the disappearing resin to produce a resin mixture. The mixing ratio is preferably 10 to 90% by weight of the disappearing resin based on 10 to 90% by weight of the support precursor resin. Herein, the disappearing resin is preferably selected from resins that are compatible with the carbonizable resin. The method of compatibilizing the resins may be mixing of the resins alone or addition of a solvent. Such a combination of the carbonizable resin and the disappearing resin is not limited, and examples include polyacrylonitrile/polyvinyl alcohol, polyacrylonitrile/polyvinyl phenol, polyacrylonitrile/polyvinyl pyrrolidone, and polyacrylonitrile/polylactic acid. The obtained resin mixture compatibilized is preferably subjected to phase separation during the molding process. By such a means, a co-continuous phase separation structure can be generated. The method for phase separation is not limited, and examples thereof include a thermally induced phase separation method and a non-solvent induced phase separation method.

Examples of the means for finally obtaining the porous structure further include a method of adding a particle that disappears by post heating during carbonization or the like or by washing after carbonization. Examples of the particle include metal oxides, talc, and silica, and examples of the metal oxides include magnesium oxide, aluminum oxide, and zinc oxide. The above-described particle is preferably mixed with the support precursor resin before the molding and removed after the molding. The removal method can be appropriately selected according to the manufacturing conditions and the properties of the particle used. For example, the support precursor resin may be decomposed and removed simultaneously with the carbonization of the support precursor resin, or may be washed before or after the carbonization. The washing liquid can be appropriately selected from water, an alkaline aqueous solution, an acidic aqueous solution, an organic solvent, and the like according to the properties of the particle used.

In the case that the method of mixing the support precursor resin with the disappearing resin to produce a resin mixture is employed as the means for finally obtaining the porous structure, the subsequent manufacturing steps are as follows.

In the case that a fibrous separation membrane is produced, a precursor of a porous carbon support can be formed by solution spinning. Solution spinning is a method of obtaining a fiber by dissolving a resin in some solvent to produce a spinning stock solution, and passing the spinning stock solution through a bath containing a solvent that serves as a poor solvent for the resin to solidify the resin. Examples of the solution spinning include dry spinning, dry-wet spinning, and wet spinning.

Furthermore, it is possible to open pores on the surface of a porous carbon support by appropriately controlling the spinning conditions. For example, in the case that a fiber is spun using the non-solvent induced phase separation method, examples of the technique of opening pores include a technique of appropriately controlling the composition and the temperature of the spinning stock solution or the coagulation bath, and a technique of discharging the spinning solution from the inner tube, and simultaneously discharging a solution in which the same solvent as that of the spinning stock solution and the disappearing resin are dissolved from the outer tube.

The fiber spun by the above-described method can be coagulated in the coagulation bath, followed by washing with water and drying to produce a precursor of a porous carbon support. Examples of the coagulating liquid include water, ethanol, saline, and a mixed solvent containing any of these liquids and the solvent used in step 1. In addition, the fiber can be immersed in a coagulation bath or a water bath before a drying step to elute the solvent or the disappearing resin.

The precursor of a porous carbon support can be subjected to an infusibilization treatment before a carbonization treatment. The method of the infusibilization treatment is not limited, and a publicly known method can be employed.

The precursor of a porous carbon support subjected to the infusibilization treatment as necessary is finally carbonized into a porous carbon support. The carbonization is preferably performed by heating in an inert gas atmosphere. Herein, examples of the inert gas include helium, nitrogen, and argon. The flow rate of the inert gas is required to be a flow rate at which the oxygen concentration in the heating device can be sufficiently lowered, and it is preferable to appropriately select an optimal flow rate value according to the size of the heating device, the supplied amount of the raw material, the carbonization temperature, and the like. The disappearing resin may be removed by thermal decomposition with heat generated during the carbonization.

The carbonization temperature is preferably 500° C. or more and 2,400° C. or less. Herein, the carbonization temperature is the maximum attained temperature during the carbonization treatment. From the viewpoints of suppressing the dimensional change and improving the function as a support, the carbonization temperature is more preferably 900° C. or more. From the viewpoints of reducing the brittleness and improving the handleability, the carbonization temperature is more preferably 1,500° C. or less.

[Surface Treatment of Porous Carbon Support]

Before the carbonizable resin layer is formed on the porous carbon support in step 2 described below, the porous carbon support may be subjected to a surface treatment in order to improve adhesion to the carbonizable resin layer. Examples of the surface treatment include an oxidation treatment and a chemical coating treatment. Examples of the oxidation treatment include chemical oxidation by nitric acid or sulfuric acid, electrolytic oxidation, and vapor phase oxidation. Examples of the chemical coating treatment include addition of a primer or a sizing agent to the porous carbon support.

[Step 2: Step of Forming Carbonizable Resin Layer]

Step 2 is a step of forming, on the porous carbon support prepared in step 1, a carbonizable resin layer serving as a precursor of a dense carbon layer. The thickness of the dense carbon layer can be arbitrarily determined by producing the porous carbon support and the dense carbon layer in separate steps. Therefore, the structure of the separation membrane can be easily designed, for example, the permeation rate of a fluid can be improved by reducing the thickness of the dense carbon layer.

For the carbonizable resin, various resins exhibiting fluid separation properties after carbonization can be employed. Specific examples of the carbonizable resin include polyacrylonitrile, aromatic polyimides, polybenzoxazole, aromatic polyamides, polyphenylene ether, phenol resins, cellulose acetate, polyfurfuryl alcohol, polyvinylidene fluoride, lignin, wood tar, and polymers of intrinsic microporosity (PIMs). The resin layer is preferably polyacrylonitrile, an aromatic polyimide, polybenzoxazole, an aromatic polyamide, polyphenylene ether, or a polymer of intrinsic microporosity (PIM) because such a resin layer has an excellent permeation rate of a fluid and an excellent separation property, and the resin layer is more preferably polyacrylonitrile or an aromatic polyimide. The carbonizable resin may be the same as or different from the above-described support precursor resin.

The method for forming the carbonizable resin layer is not limited, and a publicly known method can be employed. A general forming method is a method of applying the carbonizable resin as it is to the porous carbon support. It is possible to employ a method of applying a precursor of the resin to the porous carbon support, and then reacting the precursor to form the carbonizable resin layer, or a counter diffusion method of flowing a reactive gas or solution from the outside and inside of the porous carbon support to cause a reaction. Examples of the reaction include polymerization, cyclization, and crosslinking reaction by heating or a catalyst.

Examples of the coating method for forming the carbonizable resin layer include a dip coating method, a nozzle coating method, a spray method, a vapor deposition method, and a cast coating method. From the viewpoint of ease of the manufacturing method, a dip coating method or a nozzle coating method is preferable in the case that the porous carbon support is fibrous, and a dip coating method or a cast coating method is preferable in the case that the porous carbon support is film-like.

The dip coating method is a method of immersing the porous carbon support in a coating stock solution containing a solution of the carbonizable resin or a precursor of the resin, and then withdrawing the porous carbon support from the coating stock solution.

The viscosity of the coating stock solution in the dip coating method is arbitrarily determined according to conditions such as the surface roughness of the porous carbon support, the withdrawal speed, and the desired film thickness. When the coating stock solution is viscous, a uniform resin layer can be formed. Therefore, the shear viscosity at a shear rate of 0.1 s⁻¹ is preferably 10 mPa·s or more, and more preferably 50 mPa·s or more. The lower the viscosity of the coating stock solution is, the thinner the film is and the higher the permeation rate of a fluid is. Therefore, the viscosity of the coating stock solution is preferably 1,000 mPa·s or less, and more preferably 800 mPa·s or less.

The withdrawal speed of the porous carbon support in the dip coating method is also arbitrarily determined according to the coating conditions. A high withdrawal speed provides a thick carbonizable resin layer, and can suppress a defect. Therefore, the withdrawal speed is preferably 1 mm/min or more, and more preferably 10 mm/min or more. If the withdrawal speed is too high, there is a possibility that the carbonizable resin layer will have a non-uniform film thickness, resulting in a defect, or the carbonizable resin layer will have a large film thickness, resulting in decrease of the permeation rate of a fluid. Therefore, the withdrawal speed is preferably 1,000 mm/min or less, and more preferably 800 mm/min or less. The temperature of the coating stock solution is preferably 20° C. or more and 80° C. or less. When the coating stock solution has a high temperature, the coating stock solution has low surface tension to improve the wettability to the porous carbon support, and the carbonizable resin layer has a uniform thickness.

The nozzle coating method is a method of laminating a resin or a resin precursor on the porous carbon support by passing the porous carbon support through a nozzle filled with a coating stock solution that is a solution of the carbonizable resin or a precursor of the resin. The viscosity and temperature of the coating stock solution, the nozzle diameter, and the passing speed of the porous carbon support can be arbitrarily determined.

[Infusibilization Treatment]

The porous carbon support with the carbonizable resin layer formed thereon (hereinafter referred to as “porous carbon support/carbonizable resin layer composite”) produced in step 2 may be subjected to an infusibilization treatment before the carbonization treatment (step 3). The method for the infusibilization treatment is not limited, and conforms to the infusibilization treatment for the precursor of the porous carbon support described above.

[Step 3: Step of Forming Dense Carbon Layer]

Step 3 is a step of heating the porous carbon support/carbonizable resin layer composite produced in step 2 and further subjected to the infusibilization treatment as necessary to carbonize the carbonizable resin layer, whereby a dense carbon layer is formed.

In this step, the porous carbon support/carbonizable resin layer composite is preferably heated in an inert gas atmosphere. Herein, examples of the inert gas include helium, nitrogen, and argon. The flow rate of the inert gas is required to be a flow rate at which the oxygen concentration in the heating device can be sufficiently lowered, and it is preferable to appropriately select an optimal flow rate value according to the size of the heating device, the supplied amount of the raw material, the carbonization temperature, and the like. Although there is no upper limit on the flow rate of the inert gas, it is preferable to appropriately set the flow rate depending on the temperature distribution or the design of the heating device from the viewpoint of economic efficiency and of reducing the temperature change in the heating device.

Moreover, it is possible to chemically etch the surface of the porous carbon support to control the pore diameter size at the surface of the porous carbon support by heating the porous carbon support/carbonizable resin layer composite in a mixed gas atmosphere of the above-described inert gas and an active gas. Examples of the active gas include oxygen, carbon dioxide, water vapor, air, and combustion gas. The concentration of the active gas in the inert gas is preferably 0.1 ppm or more and 100 ppm or less.

The carbonization temperature in this step can be arbitrarily determined within a range in which the permeation rate and the separation factor of the fluid separation membrane are improved, and is preferably lower than the carbonization temperature for carbonizing the precursor of the porous carbon support in step 1. In this case, the permeation rate of a fluid and the separation performance can be improved while the hygroscopic dimensional change rates of the porous carbon support and the fluid separation membrane are reduced to suppress the breakage of the fluid separation membrane in a separation module. The carbonization temperature in this step is preferably 500° C. or more, and more preferably 550° C. or more. Furthermore, the carbonization temperature is preferably 850° C. or less, and more preferably 800° C. or less.

Another preferable aspect and the like of carbonization conform to those of carbonization of the precursor of the porous carbon support described above.

2. Step of Adsorbing Aromatic Compound and Water Next, the aromatic compound and water are adsorbed on the fluid separation membrane thus prepared. This step may be performed as a continuous step or a batch step.

The method of adsorbing the aromatic compound is not particularly limited, and it is possible to appropriately select a method such as immersion of the fluid separation membrane in the liquid aromatic compound or exposure of the fluid separation membrane to the gas aromatic compound from the viewpoints of the adsorption amount, manufacturing efficiency, and the like. In adsorbing the aromatic compound, it is preferable to appropriately perform heating or stirring from the viewpoint of improving the adsorption efficiency.

The method of adsorbing water is also not particularly limited, and it is possible to appropriately select a method such as immersion of the fluid separation membrane in water or exposure of the fluid separation membrane to water vapor from the viewpoints of the adsorption amount, manufacturing efficiency, and the like. In adsorbing water, an adsorption condition such as appropriate heating or stirring can be selected so that a desired adsorption amount is obtained.

Furthermore, it is preferable that the aromatic compound and water be mixed and simultaneously adsorbed from the viewpoint of efficiency or the viewpoints of safety and facility maintenance. In the case that the aromatic compound is a solid, it is preferable to dissolve the aromatic compound in water or a solvent that can dissolve the aromatic compound in advance before the above-described adsorption treatment is performed.

### EXAMPLES

Preferable Examples of the present invention will be described in the following, but the following description should not be construed as limiting the present invention.

[Method of Evaluation]

(Measurement of Adsorption Amounts of Aromatic Compound and Water)

The adsorption amounts of the aromatic compound and water were quantified by temperature programmed desorption-mass spectrometry (TPD-MS). The specific procedure is shown below. First, the surface of the fluid separation membrane was lightly wiped with a cloth. Next, a heating device equipped with a temperature controller was directly connected to a mass spectrometer, the fluid separation membrane was heated in a helium atmosphere, and the concentration of the gas generated from the fluid separation membrane during the heating was analyzed to determine the adsorption amounts of toluene, benzene, and water on the fluid separation membrane. In the temperature program, the temperature was first raised from room temperature to 80° C. at 10° C./min (step 1), held at 80° C. for 30 minutes (step 2), further raised to 180° C. at 10° C./min (step 3), and held at 180° C. for 30 minutes (step). The total of the amount of each of toluene, benzene, and water generated from step 1 through step 4 was obtained as the adsorption amount. The aromatic compound adsorption amount obtained only from the aromatic compound gas generated in steps 1 and 2 is named Aa (ppm), and the aromatic compound adsorption amount obtained only from the amount of the aromatic compound gas generated in steps 3 and 4 is named Ba (ppm), and similarly, the water adsorption amount obtained only from the water vapor generated in steps 1 and 2 is named Aw (ppm), and the water adsorption amount obtained only from the amount of the water vapor generated in steps 3 and 4 is named Bw (ppm). Ba/Aa and Bw/Aw were calculated.

(Generation Amount Curve During Heating of Aromatic Compound and Water)

In temperature programmed desorption-mass spectrometry (TPD-MS), the amounts of toluene, benzene, and water generated were online measured while the fluid separation membrane according to the present invention was heated from room temperature to 300° C. at 10° C./min, and at this time, the number of peaks of the curve produced by plotting the amount of toluene, benzene, or water generated with respect to the temperature change was confirmed. In order to exclude the influence of the liquid film and the liquid droplet on the surface of the fluid separation membrane, when the fluid separation membrane was visually wet, the surface of the fluid separation membrane was wiped with a rag or the like before the measurement was performed.

(Measurement of Gas Separation Factor)

Ten fluid separation membranes having a length of 10 cm were bundled and housed in a stainless steel casing having an outer diameter of ϕ6 mm and a wall thickness of 1 mm, the end of the bundled fluid separation membranes was fixed to the inner face of the casing with an epoxy resin adhesive, and both the ends of the casing were sealed to produce a fluid separation membrane module, and the gas permeation rate was measured.

The measured gases were carbon dioxide and methane, and the pressure changes of the carbon dioxide and the methane at the permeation side per unit time were measured by an external pressure system at a measurement temperature of 25° C. in accordance with the pressure sensor method of JIS K7126-1 (2006). Herein, the pressure difference between the supply side and the permeation side was set to 0.11 MPa (82.5 cmHg).

Then, the permeation rate Q of the gas that had permeated was calculated by the formula described below, and the separation factor α was calculated as the ratio of carbon dioxide/methane permeation rates. Note that the term “STP” means standard conditions. The membrane area was calculated from the outer diameter of the fluid separation membrane and the length of the region contributing to gas separation in the fluid separation membrane.

Permeation rate Q=[gas permeation volume (cm³·STP)]/[membrane area (cm²)×time(s)×pressure difference (cmHg)]

The gas separation factor immediately after the start and the gas separation factor after 100 hours were measured. Furthermore, the latter was divided by the former to determine the separation factor retention rate after 100 hours of use.

### Example 1

In a separable flask, 70 g of polyacrylonitrile (MW: 150,000) manufactured by Polysciences, Inc., 70 g of polyvinyl pyrrolidone (MW: 40,000) manufacturedby Sigma-Aldrich Co. LLC., and, as a solvent, 400 g of dimethyl sulfoxide (DMSO) manufactured by WAKENYAKU CO., LTD. were put, and the mixture was stirred and refluxed for 2.5 hours to prepare a solution at 135° C.

The obtained solution was cooled to 25° C., then the solution was discharged from the inner tube of a sheath-core double spinneret at 3.5 mL/min, a 90% by weight aqueous solution of DMSO was simultaneously discharged from the outer tube at 5.3 mL/min, and then the solutions were led to a coagulation bath containing pure water of 25° C., then withdrawn at a speed of 5 m/min, and wound up on a roller to obtain an original yarn. At this time, the air gap was 9 mm, and the immersion length in the coagulation bath was 15 cm.

The obtained original yarn was translucent and phase separation was caused in the original yarn. The obtained original yarn was washed with water and then dried at 25° C. for 24 hours in a circulation dryer to produce an original yarn.

After that, the dried original yarn was passed through an electric furnace at 255° C. and heated for 1 hour in an oxygen atmosphere to perform infusibilization treatment.

Subsequently, the infusibilized original yarn was carbonized under the conditions of a nitrogen flow rate of 1 L/min, a temperature rise rate of 10° C./min, a maximum temperature of 1,000° C., and a holding time of 1 minute to produce a porous carbon support. When the cross section was observed, a co-continuous porous structure was seen.

Then, 50 g of polyacrylonitrile (MW: 150,000) manufactured by Polysciences, Inc. and 400 g of dimethyl sulfoxide (DMSO) manufactured by WAKENYAKU CO., LTD. were put in a separable flask, the mixture was stirred and refluxed for 1.5 hours to prepare a solution at 135° C., and the solution was cooled to 25° C. Meanwhile, the porous carbon support was immersed, withdrawn at a speed of 10 mm/min, subsequently immersed in water to remove the solvent, and dried at 50° C. for 24 hours to produce a fluid separation membrane in which polyacrylonitrile was laminated on the porous carbon support.

Subsequently, the fluid separation membrane was carbonized under the conditions of a nitrogen flow rate of 1 L/min, a temperature rise rate of 10° C./min, a maximum temperature of 600° C., and a holding time of 1 minute to obtain a fluid separation membrane having a hollow fiber shape. A dense carbon layer was present on the outer surface, and the inside had a co-continuous structure including carbon.

Furthermore, 250 mL of toluene manufactured by KANTO CHEMICAL CO., INC., 250 mL of benzene manufactured by KANTO CHEMICAL CO., INC., and 250 mL of pure water were mixed and heated to 50° C., and the fluid separation membrane was exposed to the vapor of the mixture for 24 hours.

Then, the adsorption amounts of toluene, benzene, and water and the number of peaks of each generation amount curve during heating were confirmed, and the gas separation factor was measured.

### Example 2

A fluid separation membrane was obtained in the same manner as in Example 1. Furthermore, 250 mL of toluene manufactured by KANTO CHEMICAL CO., INC. and 250 mL of pure water were mixed and heated to 50° C., and the fluid separation membrane was exposed to the vapor of the mixture for 24 hours.

Then, the adsorption amounts of toluene, benzene, and water and the number of peaks of each generation amount curve during heating were confirmed, and the gas separation factor was measured.

### Example 3

A fluid separation membrane was obtained in the same manner as in Example 1. Furthermore, 250 mL of benzene manufactured by KANTO CHEMICAL CO., INC. and 250 mL of pure water were mixed and heated to 50° C., and the fluid separation membrane was exposed to the vapor of the mixture for 24 hours.

Then, the adsorption amounts of toluene, benzene, and water and the number of peaks of each generation amount curve during heating were confirmed, and the gas separation factor was measured.

### Example 4

A fluid separation membrane was obtained in the same manner as in Example 1. Furthermore, 250 mL of toluene manufactured by KANTO CHEMICAL CO., INC. and 250 mL of pure water were mixed and heated to 50° C., and the fluid separation membrane was exposed to the vapor of the mixture for 4 hours.

Then, the adsorption amounts of toluene, benzene, and water and the number of peaks of each generation amount curve during heating were confirmed, and the gas separation factor was measured.

### Comparative Example 1

A fluid separation membrane was obtained in the same manner as in Example 1. After that, adsorption treatment was not performed. The adsorption amounts of toluene, benzene, and water and the number of peaks of each generation amount curve during heating were confirmed, and the gas separation factor was measured.

### Comparative Example 2

A fluid separation membrane was obtained in the same manner as in Example 1. Furthermore, 600 mL of water was heated to 50° C., and the fluid separation membrane was exposed to the vapor for 24 hours.

Then, the adsorption amounts of toluene, benzene, and water and the number of peaks of each generation amount curve during heating were confirmed, and the gas separation factor was measured.

The evaluation results of the fluid separation membranes produced in Examples and Comparative Examples are shown in Table 1.

TABLE 1

| | | | | | | | | | Carbon dioxide/methane separation factor | | |
|---|---|---|---|---|---|---|---|---|---|---|---|
| | | | | | | | | | | | Separation |
| | Adsorption amount | | | | | Number of peaks of generation | | | | | factor |
| | Toluene | Benzene | Water | | | amount curve during heating | | | Immediately | After 100 | retention |
| | (ppm) | (ppm) | (ppm) | Ba/Aa | Bw/Aw | Toluene | Benzene | Water | after start | hours | rate |
| Example 1 | 310 | 22 | 30,000 | 0.61 | 0.37 | 2 | 2 | 2 | 5,889 | 5,712 | 0.97 |
| Example 2 | 250 | 0 | 29,000 | 0.50 | 0.31 | 2 | 0 | 2 | 4,267 | 4,048 | 0.95 |
| Example 3 | 0 | 30 | 22,000 | 0.31 | 0.33 | 0 | 2 | 2 | 3,963 | 3,686 | 0.93 |
| Example 4 | 25 | 0 | 4,100 | 0.22 | 0.11 | 1 | 0 | 1 | 1,829 | 1,628 | 0.89 |
| Comparative | 0 | 0 | 1,500 | — | 1.26 | 0 | 0 | 1 | 990 | 485 | 0.49 |
| Example 1 | | | | | | | | | | | |
| Comparative | 0 | 0 | 22,000 | — | 1.26 | 0 | 0 | 2 | 3,023 | 2,150 | 0.71 |
| Example 2 | | | | | | | | | | | |

1. A fluid separation membrane comprising a separation layer including a dense layer, wherein
2 to 10,000 ppm of a total of a monocyclic or bicyclic aromatic compound being liquid or solid at 16° C. under atmospheric pressure and 10 to 250,000 ppm of water are adsorbed.

2. The fluid separation membrane according to claim 1, wherein the aromatic compound is at least one selected from the group consisting of toluene, benzene, ethylbenzene, cumene, phenol, benzyl alcohol, anisole, benzaldehyde, benzoic acid, acetophenone, benzenesulfonic acid, nitrobenzene, aniline, thiophenol, benzonitrile, styrene, xylene, cresol, catechol, resorcinol, hydroquinone, phthalic acid, isophthalic acid, terephthalic acid, salicylic acid, and toluidine.

3. The fluid separation membrane according to claim 2, wherein the aromatic compound is at least one selected from the group consisting of toluene, benzene, and xylene.

4. The fluid separation membrane according to claim 3, wherein the aromatic compound is toluene.

5. The fluid separation membrane according to claim 4, wherein 2 ppm or more of toluene is adsorbed.

6. The fluid separation membrane according to claim 4, wherein the aromatic compound is also benzene.

7. The fluid separation membrane according to claim 6, wherein a ratio of a toluene adsorption amount (ppm) to a benzene adsorption amount (ppm) is 2 or more and 200 or less.

8. The fluid separation membrane according to claim 1, wherein a ratio of a water adsorption amount (ppm) to an adsorption amount of the aromatic compound (ppm) is 0.5 or more.

9. The fluid separation membrane according to claim 1, wherein a curve produced by plotting an amount of the aromatic compound of one kind generated in temperature programmed desorption-mass spectrometry with respect to a temperature change has two or more peaks, the amount of the aromatic compound being online measured while a temperature is raised from room temperature to 300° C. at 10° C./min.

10. The fluid separation membrane according to claim 1, wherein a curve produced by plotting an amount of water generated in temperature programmed desorption-mass spectrometry with respect to a temperature change has two or more peaks, the amount of water being online measured while a temperature is raised from room temperature to 300° C. at 10° C./min.

11. The fluid separation membrane according to claim 1, wherein the dense layer includes an inorganic material.

12. The fluid separation membrane according to claim 11, wherein the inorganic material is carbon.

13. The fluid separation membrane according to claim 1, wherein the dense layer is formed on a surface of a support having a porous structure.

14. The fluid separation membrane according to claim 13, wherein the porous structure is a three-dimensional network structure.

15. The fluid separation membrane according to claim 14, wherein the three-dimensional network structure is a co-continuous porous structure.
